(19) United States
(12) Patent Application Publication
(10) Pub. No.: US 2016/0256886 A1
(43) Pub. Date: Sep. 8, 2016

(54) MASKING TAPE

(71) Applicant: JTAPE LIMITED, Macclesfield Cheshire (GB)

(72) Inventor: Oliver Jevons, Macclesfield, Cheshire (GB)

(21) Appl. No.: 15/033,413

(22) PCT Filed: Nov. 4, 2014
(86) PCT No.: PCT/GB2014/053284

§ 371 Date: Apr. 29, 2016

(30) Foreign Application Priority Data
Nov. 4, 2013 (GB) 1319408.9

(51) Int. Cl. B05B 15/04; B32B 5/18; B32B 7/12; B05D 7/00

(52) U.S. Cl. CPC B05B 15/0456; B05D 7/54; B32B 5/18; B32B 7/12; B32B 2405/00

(57) ABSTRACT

A foam tape having a flat cross-section with rounded edges and, on one face, an adhesive stripe covering substantially all of the face except for between 2 and 3 mm either side, and being capable of taking on and maintaining a curvature, when adhered by its adhesive to a surface, on a radius of 160 mm without kinking.

This invention relates to masking tapes, more particularly masking tapes for the automotive refinishing trade.

Foam masking tape are known primarily intended to fit between doors and door surrounds to stop ingress of paint spray to the vehicle interior. A typical such tape is 3M's Soft Edge Tape, which comprises an essentially circular section foam tape with an adhesive stripe. The tape is applied to all around the door surround with the door open, attached by the adhesive stripe. The door is then closed on the tape which forms a seal and absorbs excess paint.

This tape is sometimes used for masking along panel swage lines when blending new paint with existing paintwork, for which purpose, however, it is not entirely suitable.

The present invention provides a tape better adapted to blending along swage lines, and which is also suitable for numerous other masking jobs.

The invention comprises a foam tape having a flat cross-section with rounded edges and, on one face, an adhesive stripe covering substantially all of the face except for between 2 and 3 mm either side, and being capable of taking on and maintaining a curvature, when adhered by its adhesive to a surface, on a radius of 160 mm without kinking.

The tape may be between 4 and 6 mm thick and between 12 and 17 mm wide.

The rounded edges may be substantially semi-circular in cross section.

The slight overhang provided by the rounded edge partially shields the panel beneath it, some paint being carried in by turbulence.

Setting back the adhesive from the edge avoids a hard paint edge forming, as the paint does not reach the adhesive edge, being absorbed by the foam.

The tape may be made from a sheet of foam by making a cold-weld seam as described in EP0384626.

The tape may have an edgewise bead adapted to be removed from the tape after a first coat e.g. of primer has been applied, without needing to disturb the attachment of the tape to the panel, whereby a top coat can be applied to cover the edge of the primer. The edgewise bead can be formed by making a cold weld seam which is easily removable, as described in GB2495333. The cold weld seam is effected by a notched roller that can substantially separate the bead from the seam but which leaves it more firmly attached at ‘hesitation’ points at intervals, say every 100 mm.

The invention also comprises a method of masking to blend paint being applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape.

The overhanging edge of the tape ‘feathers’ the spray such that its thickness tapers off towards the edge whereby to blend the new and existing paintwork to leave no visible join and no hard paint edge.

In practice, panels are usually painted up to a swage line, which may be a curved or flat fold swage line, and whether salient or inverted. It is relatively easy to apply the tape smoothly along such a line, but it is important that, with curved swage lines, the tape is applied smoothly and without kinking or buckling, that would leave small regions of tape lifted off the surface to allow paint to penetrate unevenly.

The invention also comprises a method of masking to blend successive coats of paint being applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape in which the tape has a removable bead, a first coat being applied with the bead attached, the bead then being detached, and the second coat applied.

The tape can be used around wheel arches, screen gaskets and rubbers, bumper flutes, alloy wheel rims, narrow panel-gap apertures with door seals, and rim edges around filler caps, in the same way as along swage lines.

Embodiments of masking tape and a method of masking according to the invention will now be described with reference to the accompanying drawings, in which:

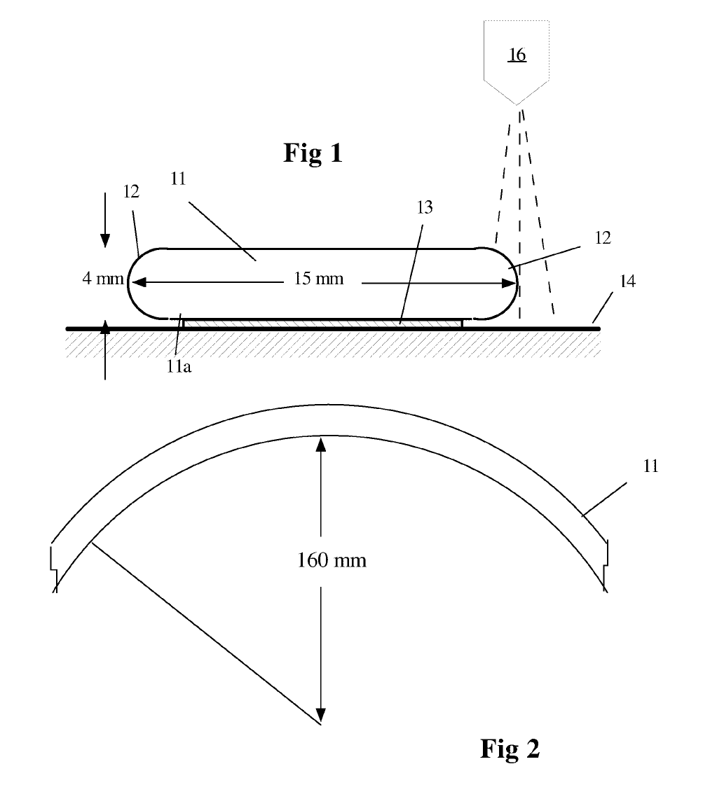

FIG. 1 is a cross section through a first embodiment of tape applied to a surface;

FIG. 2 is a face-on view of the tape of FIG. 1 applied curved to a surface;

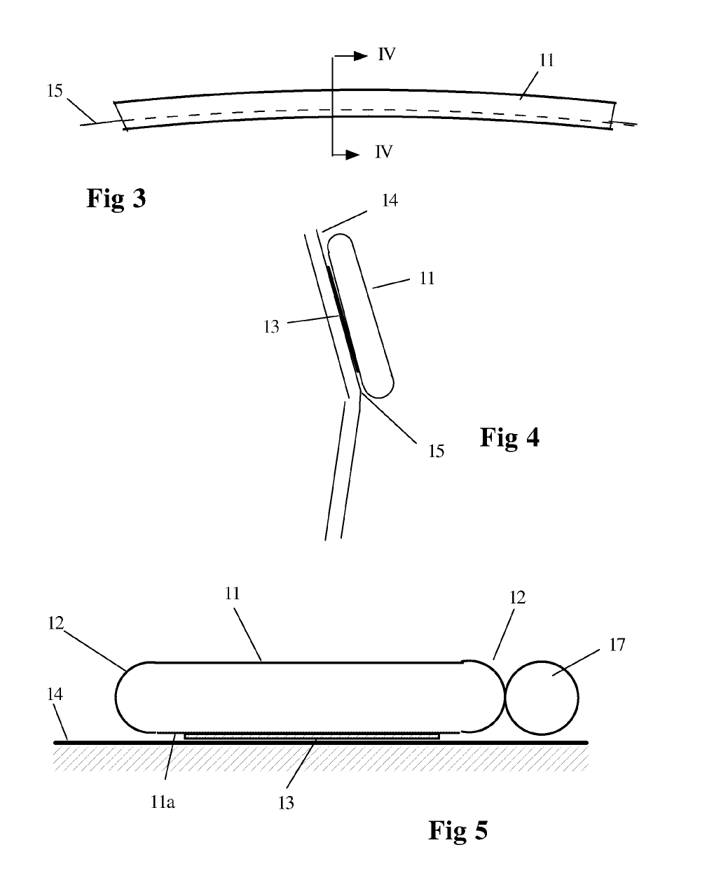

FIG. 3 is a face-on view of the tape of FIG. 1 applied along a swage line of a panel;

FIG. 4 is a cross section on line IV-IV of FIG. 3:

FIG. 5 is a cross section like FIG. 1 through a second embodiment of tape.

The drawings illustrate comprises a foam tape 11 having a flat cross-section with rounded edges 12 and, on one face, 11a, an adhesive stripe 13 covering substantially all of the face 11a except for between 2 and 3 mm either side, and being capable of taking on and maintaining a curvature, when adhered by its adhesive 13 to a surface 14, on a radius of 160 mm without kinking, as particularly seen in FIG. 2.

The tape 11 is 4 mm thick and 15 mm wide.

The rounded edges 12 are substantially semi-circular in cross section.

The slight overhang provided by the rounded edge 12 partially shields the panel 14 beneath it, some paint being carried in by turbulence. It is, of course, only necessary for one edge of the tape 11 to perform this shielding function, but it is convenient to have both edges the same so that orientation of the tape is immaterial.

If the tape 11 is made by a method as described in EP0384626, both edges 12 will be essentially rounded so as to perform the shielding function.

Setting back the adhesive 13 from the edge 12 avoids a hard paint edge forming, as the paint does not reach the adhesive 13 edge, being absorbed by the foam.

FIGS. 1 and 2 show the tape 11 applied to a flat surface 14. However, it is particularly beneficial when painting up to a swage line 15, as illustrated in FIGS. 3 and 4. Many swage lines are curved, some quite markedly, and the tape 11 can conform to essentially all swage line curvatures without kinking or buckling, and without putting so much tension on the adhesive as to detach it from the surface.

In use, and particularly as seen in FIG. 1, paint from a spray gun 16 is partially shielded beneath the rounded edge 12, some paint being carried beneath the edge 12 by turbulence induced in the spray by the edge 12 itself. The thickness of the paint thus tapers at the edge, leaving no hard paint edge that would need to be rubbed down.

FIG. 5 shows a second tape embodiment in which at one edge 12 there is a removable bead 17, also, of course, having a rounded edge. This is useful when applying two coats of paint in succession, a primer, say, then a lacquer. The primer is applied with the bead 17 in place. The bead is then removed, leaving the rest of the tape 11 in place.

Now, the lacquer can be applied over the primer, and it will cover the edge of the primer but again be feathered so as to taper in thickness.

A foam tape having a flat cross-section with rounded edges and, on one face, an adhesive stripe covering substantially all of the face except for between 2 and 3 mm either side, and being capable of taking on and maintaining a curvature, when adhered by its adhesive to a surface, on a radius of 160 mm without kinking.

The tape may be between 4 and 6 mm thick and between 12 and 17 mm wide.

The rounded edges may be substantially semi-circular in cross section.

The slight overhang provided by the rounded edge partially shields the panel beneath it, some paint being carried in by turbulence.

Setting back the adhesive from the edge avoids a hard paint edge forming, as the paint does not reach the adhesive edge, being absorbed by the foam.

The tape may be made from a sheet of foam by making a cold-weld seam as described in EP0384626.

The tape may have an edgewise bead adapted to be removed from the tape after a first coat e.g. of primer has been applied, without needing to disturb the attachment of the tape to the panel, whereby a top coat can be applied to cover the edge of the primer. The edgewise bead can be formed by making a cold weld seam which is easily removable, as described in GB2495333.

The invention also comprises a method of masking to blend paint being applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape.

The overhanging edge of the tape ‘feathers’ the spray such that its thickness tapers off towards the edge whereby to blend the new and existing paintwork to leave no visible join and no hard paint edge.

In practice, panels are usually painted up to a swage line, which may be a curved or flat fold swage line, and whether salient or inverted. It is relatively easy to apply the tape smoothly along such a line, but it is important that, with curved swage lines, the tape is applied smoothly and without kinking or buckling, that would leave small regions of tape lifted off the surface to allow paint to penetrate unevenly.

The invention also comprises a method of masking to blend successive coats of paint being applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape in which the tape has a removable bead, a first coat being applied with the bead attached, the bead then being detached, and the second coat applied.

1. A foam tape having a flat cross-section with rounded edges and, on one face, an adhesive stripe covering substantially all of the face except for between 2 and 3 mm either side, and being capable of taking on and maintaining a curvature, when adhered by its adhesive to a surface, on a radius of 160 mm without kinking.

2. A foam tape according to claim 1, being between 4 and 6 mm thick and between 12 and 17 mm wide.

3. A foam tape according to claim 1, in which the rounded edges are substantially semi-circular in cross section.

4. A foam tape according to claim 1, comprising a strip from a foam sheet having a cold weld seam along a rounded edge.

5. A foam tape according to claim 1, having an edgewise bead adapted to be removed from the tape after a first coat e.g. of primer has been applied, without needing to disturb the attachment of the tape to the panel, whereby a top coat can be applied to cover the edge of the primer.

6. A foam tape according to claim 1, in which the edgewise bead is attached to the tape by a cold weld seam.

7. A foam tape according to claim 6, in which the cold weld seam has intermittent hesitation points at which it is more firmly attached to the tape.

8. A method of masking to blend paint being applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape.

9. A method according to claim 9, in which the overhanging edge of the tape ‘feathers’ the spray such that its thickness tapers off towards the edge whereby to blend the new and existing paintwork to leave no visible join and no hard paint edge.

10. A method according to claim 8, in which a panel is painted up to a swage line, which may be a curved or flat fold swage line, whether salient or inverted.

11. A method according to claim 8, in which successive coats of paint applied to a panel with an area of existing paintwork along an edge thereof, comprising applying to the existing paintwork, along the edge, a foam tape having a flat cross-section with rounded edges and, on one face, an adhesive stripe covering substantially all of the face except for between 2 and 3 mm either side, using the adhesive to attach the tape to the panel, and locating the tape such that the edge of the existing paintwork lies beneath the rounded edge of the tape in which the tape has a removable bead, a first coat being applied with the bead attached, the bead then being detached, and the second coat applied.
